(19) United States
(12) Patent Application Publication
(10) Pub. No.: US 2015/0314393 A1
(43) Pub. Date: Nov. 5, 2015

(54) Method for Laser Welding and Welded Metal Using the Same

(71) Applicant: POSCO, Pohang-si (KR)

(72) Inventor: In-Su Woo, Incheon (KR)

(21) Appl. No.: 14/424,313

(22) PCT Filed: Dec. 20, 2012
(86) PCT No.: PCT/KR2012/011169

§ 371 Date: Feb. 26, 2015

(30) Foreign Application Priority Data
Aug. 31, 2012 (KR) 10-2012-0096626

(51) Int. Cl. B23K 26/26; B23K 26/12; B23K 26/32

(52) U.S. Cl. CPC B23K 26/26; B23K 26/3206; B23K 26/123

(57) ABSTRACT

The present invention relates to a laser welding method that is capable of preventing defects such as pores or pits from being formed in a weld and improving formability of the weld during laser welding, and a welded member using the same. In the laser welding method of performing welding by irradiating laser onto a portion to be welded, there are provided a laser welding method of including supplying a shielding gas to a laser irradiation part and a rear side of the laser irradiation part, and a welded member having welds formed therethrough.

### TECHNICAL FIELD

The present invention relates to a laser welding method and, more particularly, to a laser welding method for tailor welded blanks (TWB).

### BACKGROUND ART

In the automobile industry, high strength steel materials have recently been adopted for the purpose of lightening the weight of car bodies according to the tightening of environmental regulations. In addition, the trend in forming methods is for tailor welded blanks (TWB), hydroforming and other methods to replace existing pressing processes.

Tailor welded blanks mean so-called “tailored cut and welded steel sheets”.

Tailor welded blanks are articles processed to have desired shapes by welding the cut steel sheets after cutting steel sheets with different thicknesses, strengths and materials to proper sizes and shapes. The tailor welded blanks may greatly reduce costs as compared to the case of directly welding the processed steel sheets after the processing thereof. Although applicable welding methods may include laser welding, resistance seam welding, plasma welding and others, laser welding is principally applied.

Laser welding is characterized in that it not only enables high speed production using a highly efficient energy beam, but also results in excellent weld quality. However, problems are consistently pointed out in that welding defects such as porosity and pits occur in some types of steel and steel joints. In general, pits occur under conditions in which porosity defects frequently occur, and means a defect in which welds are exposed to the surface of welding beads as gas partial pressure increases inside pores.

Since there is an increase in joints in materials of which a thickness difference is large, in order to satisfy lightening requirements of automobile bodies, porosity or pit defects occur more conspicuously, which has become a serious problem. FIG. 1 illustrates an embodiment of porosity and pit defects that may occur in the case of welding materials with different thicknesses.

There are provided the following technologies of laser welding for TWB.

Patent document 1 (Japanese Patent Laid-open Publication No. Heisei 8-174246) suggests a technology of improving press formability of the weld by controlling a tilt angle of welding beads. Specifically, the technology guarantees press formability with a step height WO between materials being in the range of tₐᵥₑ×tan 10≦d_{f}≦tₐᵥₑ×tan 30, tₐᵥₑ=(t₁+t₂)/2)/2, wherein t₁ represents a plate thickness of material of the thick plate side, and t₂ represents a plate thickness of material of the thin plate side. Although this technology reduces damage to the press mold by removing the step height of the weld, it is true that the technology is insufficient to solve the porosity or pit defects of the weld.

Patent document 2 (Japanese Patent Laid-open Publication No. Heisei 8-257773) suggests a welding method in which the butt joints are reciprocated, i.e., woven by a laser beam for the purpose of forming good welding beads on butt joints and preventing welding defects in the case of laser welding plates with different thicknesses. Although this method is capable of expanding a gap between the joints that have been pointed out consistently in laser welding, weld time is increased as the weld line is lengthened, and there is a limitation intrinsically involved in eliminating the porosity defects.

Patent document 3 (Japanese Patent Laid-open Publication No. Heisei 7-266081) suggests a solid wire having a composition comprising carbon (C), manganese (Mn) and silicon (Si) as basic components and a balance of Fe and other impurities, and an electrical resistivity of ρ≦3.2×10⁻⁷ Ω·m and a welding method using a shield gas in which inert gases such as argon (Ar) and helium (He) are mixed with active gases such as carbon dioxide (CO2) and oxygen (O2) as an arc welding wire for a surface treated steel sheet that is excellent in porosity resistance without such defects as pits, blow holes and others, and a welding construction method. The generation of pores can be suppressed by an effect of gradually reducing the heat input after increasing electrical resistivity of the wire to secure a predetermined heat input without increasing the welding current. However, it is a principle that a welding material is not basically used in the case of laser welding for TWB, and such problems are pointed out that it is difficult to secure surface qualities of the weld along with an increase in unit costs when the welding material is applied.

Patent document 4 (Japanese Patent Laid-open Publication No. 2001-138085) suggests a method of applying a shield gas in which carbon dioxide is mixed with inert gas in a mixing ratio of 80 to 95% in order to improve penetration characteristics and prevent porosity defects of the laser weld. Their effects are considered to be insignificant in keyhole welding such as laser welding, although an inert gas such as oxygen or carbon dioxide has characteristics that enable deep penetration by reducing surface tension of molten metal in ordinary heat conduction type welding. Further, in the above-mentioned patent invention, it is judged that it is necessary to examine effects of the active gas in greater detail since the result is obtained that active gas such as oxygen rather aggravates the generation of pores in the weld.

Patent document 5 (Japanese Patent Laid-open Publication No. 2001-300751) suggests a welding condition of maintaining particularly a penetration depth in a range of 1.1 to 1.2 or more of the material thickness for the purpose of sufficiently exhausting helium to the outside from the fact that helium gas supplied to suppress plasma generated in the laser welding process remains in the keyhole to result in the formation of pores. Although it is possible to control the penetration depth through the welding conditions, i.e., heat input in the case of steel material of which a target steel type has a thickness of 10 mm or more, it is actually difficult to secure a predetermined penetration thickness since the range of the welding conditions is narrow in the case of a thick material such as the target steel material of the present invention.

Patent document 6 (Japanese Patent Laid-open Publication No. 2010-89138) suggests a method of reducing zinc vapor in molten metal by adding additives to zinc in order to suppress the formation of pores in laser welding of a zinc surface treated steel sheet, thereby reacting zinc with the additives before zinc vapor is generated. However, this method involves many problems in actual construction such as control of the coating amount in addition to an increase in construction unit price.

Patent document 7 (Japanese Patent Laid-open Publication No. 2003-311453) pertains to a method of easily exhausting zinc vapor generated during the laser welding process by constantly maintaining a gap between the lap joints to suppress pores formed in lap joints of a zinc surface treated steel sheet. It is difficult to apply such technology to laser welding of tailored blank members which have a limitation in the shape of the joints, and of which butt joints are particularly targeted.

(Patent Document 1) Japanese Patent Laid-open Publication No. Heisei 8-174246

(Patent Document 2) Japanese Patent Laid-open Publication No. Heisei 8-257773

(Patent Document 3) Japanese Patent Laid-open Publication No. Heisei 7-266081

(Patent Document 4) Japanese Patent Laid-open Publication No. 2001-138085

(Patent Document 5) Japanese Patent Laid-open Publication No. 2001-300751

(Patent Document 6) Japanese Patent. Laid-open Publication No. 2010-89138

(Patent Document 7) Japanese Patent Laid-open Publication No. 2003-311453

### DISCLOSURE

### Technical Problem

An aspect of the present invention provides a laser welding method capable of preventing defects such as pores or pits from being formed in a weld and improving formability of the weld during laser welding, and a welded member using the same.

### Technical Solution

In a laser welding method of performing welding by irradiating a laser onto a weld portion, there is provided a laser welding method including supplying a shielding gas to a laser irradiation part and a rear side of the laser irradiation part.

Further, the present invention provides a laser welded member which includes a weld that is welded by irradiating a laser onto the portion to be welded, wherein 125 ppm or less by weight of nitrogen is contained in the weld.

### Advantageous Effects

The present invention has the merit of providing a tailored blank member that is capable of securing excellent welding characteristics and guaranteeing the same level of good forming properties as a base material by preventing porosity or pit defects even during laser welding of materials between which there is a thickness difference.

### DESCRIPTION OF DRAWINGS

The above and other aspects, features and other advantages of the present invention will be more clearly understood from the following detailed description taken in conjunction with the accompanying drawings, in which:

FIG. 1 is a photograph illustrating porosity and pit defects formed in welding joints of tailored welded members;

FIG. 2 is a graph illustrating the nitrogen content of a weld and the degree of porosity during laser welding;

FIG. 3 is a mimetic diagram schematically illustrating an embodiment of the welding method of the present invention;

FIG. 4 is a photograph of pores imaged through radioanalysis of welds in the Example;

FIG. 5 is a photograph observing Erichsen test results of the welds in the Example; and

FIG. 6 is a mimetic diagram illustrating a preferred laser irradiating position in the welding method of the present invention.

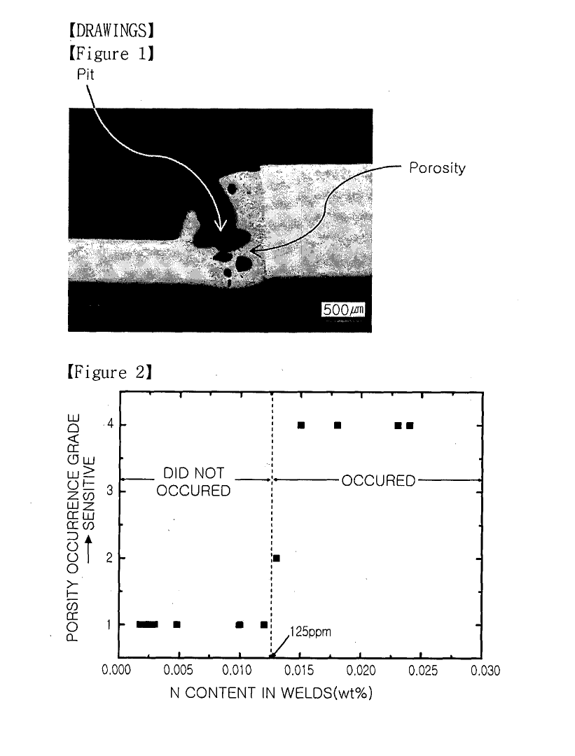

### BEST MODE

Exemplary embodiments of the present invention will now be described in detail with reference to the accompanying drawings.

The present inventors have researched the causes of porosity or pit defects in the case of performing laser welding in depth, particularly in the case of welding steel sheets with different thicknesses, in order to manufacture tailored blank members. As a result, it has been recognized that porosity defects of a laser weld are closely related with nitrogen content of the weld, which is illustrated in FIG. 2.

As illustrated in FIG. 2, it could be confirmed that porosity and pit defects were concentrically formed in the weld when about 125 ppm or more of nitrogen was contained in the weld.

Nitrogen introduced to the weld mostly comes from surrounding air in which nitrogen exists, as nitrogen gas contacting the weld surroundings by high temperature plasma generated during laser welding is dissociated and brought into contact with the weld, and the nitrogen gas is exhausted to pores due to a decrease in solid solubility during the cooling process. Therefore, the present inventors have completed the present invention by developing a method which is capable of inhibiting the growth of plasma by spraying inert gas onto the rear side (a lower laser welding portion) of the laser irradiation part as well as onto a laser irradiation part (an upper laser welding portion) during laser welding to cool plasma, and which is capable of suppressing the formation of porosity or pit defects by preventing nitrogen in the air from being directly brought into contact with plasma.

The present invention provides a method that is capable of inhibiting the formation of defects in the weld by controlling the supply of the shielding gas during laser irradiation, thereby suppressing the contact of nitrogen in the air with plasma. Furthermore, the present invention provides a laser welding method that is capable of suppressing the formation of defects in the weld by controlling the laser beam-irradiating position and the heat input.

### Mode for Invention

While the present invention has been shown and described in connection with the exemplary embodiments, it will be apparent to those skilled in the art that modifications and variations can be made without departing from the spirit and scope of the invention as defined by the appended claims. Hereinafter, the present invention will be described in detail.

First, a laser welding method of the present invention is described in detail. The laser welding method of the present invention is characterized in that a shielding gas is supplied to the laser irradiation part and the rear side of the laser irradiation part during the laser irradiation in a laser welding method of performing welding by irradiating a laser onto a portion to be welded.

The portion to be welded means a portion in which one or more steel materials are subjected to butt welding, and the two or more steel materials can be applied even when they have different thicknesses. Although the steel materials which are aimed at manufacturing automobile parts may have high strength characteristics, they are not limited to the high strength characteristics, and they are expected to be applied to all steel materials in which porosity defects cause problems during laser welding.

It is often difficult to set up a proper heat input in the case of welding joints in which steel materials with different thicknesses are welded. A thicker steel material (a so-called “thick steel sheet”) may not be sufficiently molten during welding compared to a thinner steel material (a so-called “thin steel sheet”), and if heat input is applied to the thin steel sheet based on that of the thick steel sheet, welding defects such as meltdown or pores may be easily formed, since the thin steel sheet may be excessively molten. An increase in the heat input causes the temperature of plasma to increase such that pores are easily formed, and excessively molten metal is gravitationally drooped downwardly to generate underfill or meltdown.

Accordingly, the present invention suggests a method of moving the irradiating position of a laser beam toward a thick steel sheet to first melt the thick steel sheet and then locally melt a thin steel sheet as illustrated in FIG. 6. That is, the laser in the present invention is preferably irradiated at a position that is 0.1 to 0.25 mm in distance from the interface of the steel sheets with different thicknesses to the thick steel sheet. Therefore, molten metal of the thick steel sheet moves toward the thin steel sheet to secure a predetermined neck thickness of a metal weld and contribute to strength improvement of the weld. The thin steel sheet is melted to form welding defects if the distance is less than 0.1 mm, and a phenomenon is generated in which only the thick steel sheet is melted if the distance exceeds 0.25 mm.

A heat input in the present invention is preferably 0.83 to 3.0 kW·min/m. It may be difficult to move the thick steel sheet toward the thin steel sheet since the molten amount of the thick steel sheet if the heat input is less than 0.83 kW·min/m, and there is a problem of meltdown since the thick steel sheet is excessively molten if the heat input exceeds 3.0 kW·min/m.

Types of laser welding method are not particularly limited, and they are sufficient as long as they can be applied by those skilled in the art of the present invention. Particularly, a CO₂ laser welding method among laser welding methods of the present invention is excellent in terms of the technical effect thereof. The effect of the CO₂ laser welding method can be maximized in the aspect of inhibiting the pore forming effect of the present invention since there is a high possibility of forming pores in the weld in the case of the CO₂ laser welding method.

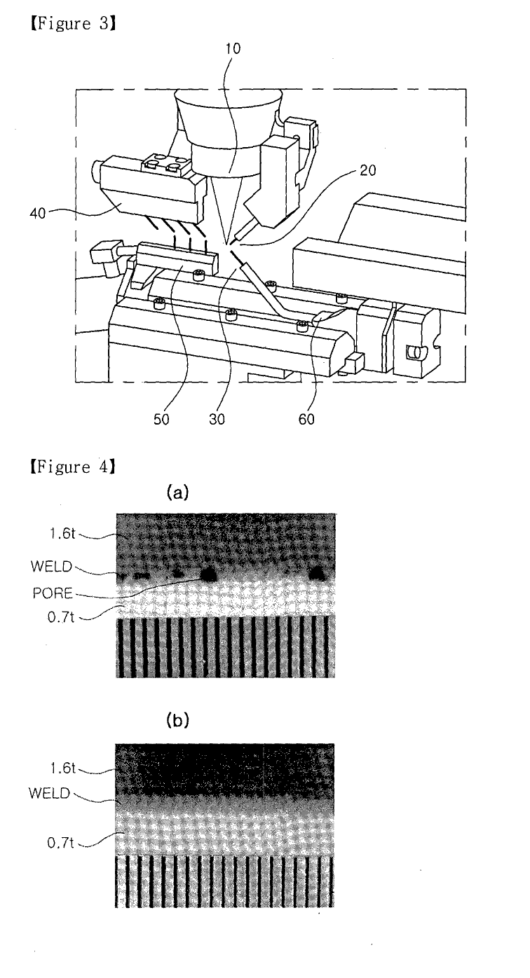

Referring to FIG. 3, the present invention is described in detail. FIG. 3 is a mimetic diagram illustrating an embodiment of a device that can be applied to the welding method of the present invention.

A laser welding method of the present invention comprises simultaneously supplying a shielding gas to a laser irradiation part and a rear side of the laser irradiation part during laser irradiation. A method of supplying the shielding gas through a coaxial nozzle 10 that is the same axial direction as the laser irradiating direction and a method of supplying the shielding gas from the lateral direction through a side nozzle 20 may be used as the method of supplying shielding gas to the laser irradiation part. The method of supplying shielding gas in the same axial direction as the laser irradiating direction has an effect of preventing scattering of the beam by blocking the reaction of laser beam with the air. On the other hand, a method of supplying shielding gas from the lateral direction has a merit that a drop in the efficiency of the laser beam in the weld can be improved by eliminating plasma generated during welding.

A laser welding method of the present invention may include supplying shielding gas to the rear side of the irradiating part through a lower nozzle 30 during the laser irradiation. There is a limitation in preventing the formation of porosity or pit defects in the weld in which shielding is performed on the irradiating surface of the weld (the top part of the weld) only. Piercing welding is conducted particularly when thin steel sheets are welded, high temperature plasma is also generated from the rear side of the weld on the same level as the top side of the weld in the case of piercing welding, and nitrogen gas is concentrically penetrated into the weld through plasma. Therefore, shielding gas may also be supplied to the rear side to block the reaction of nitrogen in the air with plasma generated from the rear side (bottom part) of the laser irradiating surface.

In the case of continuously producing products having a long weld line such as TWB, there is a design structural difficulty in shielding the entire rear side of the weld, and there is a problem that a large amount of gas is consumed to shield such a large area. The present invention can obtain an effect of effectively preventing the formation of pores or pit defects even with a small amount of shielding gas by addressing the fact that high temperature plasma contributes to the formation of pores, thereby directly spraying inert gas onto the plasma generating part. There is a merit that superior formability can be secured by suppressing the formation of porosity or pit defects, thereby inhibiting the generation of cracking and others during forming of the weld.

The method may further include additionally supplying shielding gas to the laser irradiation part or the rear side thereof from the rear side after laser irradiation in addition to supplying shielding gas to the laser irradiation part and the rear side thereof. In FIG. 3, an upper shielding box 40 and a lower shielding box 50 placed at the rear side of the welding head are means for additionally supplying shielding gas to the laser irradiation part or the rear side thereof after laser irradiation.

Laser welding is a method using a highly efficient laser beam characterized by high speed welding. In the case of laser welding, it is necessary to install the upper shielding box 40 and lower shielding box 50 at the rear side of the welding head if necessary, since there is a possibility that the weld is exposed to the air at the rear side of welding after performing welding in addition to furnishing of the coaxial nozzle 10, side nozzle 20 and lower nozzle 30 as illustrated in FIG. 3. In this case, there is an effect of improving surface materials of the weld by suppressing the mixing of nitrogen and blocking the weld from the air during cooling, thereby inhibiting an oxidation phenomenon of the weld.

Inert gases such as helium (He) gas, argon (Ar) gas, and others may be used as the shielding gas supplied, and it is also possible to use mixtures of the inert gases. Helium gas may be more effective since helium gas has higher ionization energy than argon gas such that the amount of plasma generated is decreased.

It is preferable that the shielding gas is supplied at a flow rate of 15 to 40 l/min. A good effect can be secured only when the flow rate is 15 l/min or more, and the shielding effect is dropped to increase mixing of nitrogen in the air when the flow rate is less than 15 l/min. Meanwhile, although the shielding gas is effective in preventing the formation of pores when the flow rate exceeds 40 l/min, there are problems in that the molten part is severely shaken to result in the poor quality of bead surfaces, and the welding rate should be decreased in order to compensate for the heat input due to the cooling effect. It is preferable to maintain the flow rate of the shielding gas to a range of 15 to 20 l/min since economic feasibility deteriorates if the flow rate of the shielding gas is increased.

Hereinafter, a welded member of the present invention is described in detail. The welded member of the present invention has a weld preferably comprising 125 ppm or less by weight of nitrogen.

Nitrogen of the weld is nitrogen gas taken from the surrounding air during the laser welding process, wherein the nitrogen content exceeding 125 ppm by weight increases the possibility of forming porosity or pit defects and can be a cause of cracking or fractures of the weld during forming of the weld. That is, the limit of solid solubility of nitrogen in the laser weld that is solidified into proeutectic ferrite is 125 ppm by weight. Therefore, it is preferable to control the nitrogen content of the weld to 125 ppm or less by weight to suppress the formation of porosity or pit defects in the case of a laser welding steel material that is solidified into proeutectic ferrite.

Hereinafter, the present invention will be described in more detail with reference to the following Examples and Comparative Examples. However, the following Examples and Comparative Examples are provided for illustrative purposes only, and the scope of the present invention should not be seen as being limited thereto in any manner.

### EXAMPLE 1

Cold rolled steel sheets (CR) and galvanized steel sheets (GI) having compositions (wt %, balance being Fe and unavoidable impurities) and thicknesses shown in Table 1 below were prepared, respectively.

TABLE 1

| | | | | | | Mechnical Properties | | | | | |
|---|---|---|---|---|---|---|---|---|---|---|---|
| Classi- | Composition | | | | | YP | TS | EL | Thick- | Coating amount | |
| fication | C | Mn | P | S | Si | (MP a) | (MP a) | (%) | ness | Front | Rear |
| CR-A | 0.0017 | 0.094 | 0.0087 | 0.0037 | 0.004 | 163 | 290 | 51 | 0.7 mm | — | — |
| GI-A | 0.0017 | 0.094 | 0.0087 | 0.0037 | 0.004 | 163 | 290 | 51 | 0.7 mm | 66.67 | 66.33 |
| CR-B | 0.0012 | 0.085 | 0.0103 | 0.0052 | 0.004 | 159 | 294 | 52 | 1.6 mm | — | — |
| GI-B | 0.0012 | 0.085 | 0.0103 | 0.0052 | 0.004 | 159 | 294 | 52 | 1.6 mm | 65.33 | 64.33 |

Laser welding was performed using the cold rolled steel sheets and the galvanized steel sheets of A and B. At this time, the laser welding was performed using 6 kW CO₂ laser welder, and butt welding was performed under conditions in which the formation of pores is relatively significant through a preliminary test, such as a laser output of 6 kW and a welding speed of 2 m/min.

The porosity defect of the laser weld was measured under KS B0845. When steel materials had a thickness of 10 mm or less, they were classified as grade 1 if a defect point was 1 or less within a visual test field of 10×10 mm; grade 2 if the defect point was 3 or less; grade 3 if the defect point was 6 or less, and grade 4 if the defect point exceeded 6. Herein, the defect point was given as 1 if the diameter of a pore was 1 mm or less; 2 if it was in a range of 1-2 mm; 3 if it was in a range of 2-3 mm; and 6 if it was in a range of 3-4 mm.

The formability of the laser weld was evaluated using an Erichsen tester. Positions where cracks were formed were classified in consideration of thickness, and the case in which cracks were formed in the weld was evaluated as failure and the case in which cracks were formed in a base material was evaluated as a pass.

The laser welding was performed after changing shielding conditions during the laser welding. Resultantly, the occurrence of porosities and formability were evaluated and the results are shown in Table 2 below. The shielding method in Table 2 was performed using the laser welder of FIG. 3. Referring to FIG. 3, a shielding method (10) performed in the same direction with the laser irradiation direction, a shielding method (20) performed laterally with respect to the laser irradiation direction, and a shielding method (30) performed on a rear side of a laser irradiation part are respectively represented as \textcircled{1}, \textcircled{2}, and \textcircled{3} in Table 2.

TABLE 2

| | Steel type, | | Type of | Flow rate of | Porosity | |
|---|---|---|---|---|---|---|
| Classi- | thickness | shielding | shielding | shielding | occurrence | Crack |
| fication | (mm) | method | gas | gas (l/min) | grade | position |
| Comparative | CR, | \textcircled{1} | He | 20 | 4 | weld |
| Ex. 1 | 0.7/1.6 | | | | | |
| Comparative | CR, | \textcircled{1} | Ar | 20 | 4 | weld |
| Ex. 2 | 0.7/1.6 | | | | | |
| Comparative | CR, | \textcircled{2} | He | 20 | 4 | weld |
| Ex. 3 | 0.7/1.6 | | | | | |
| Comparative | GI, | \textcircled{1} | He | 20 | 3 | weld |
| Ex. 4 | 0.7/1.6 | | | | | |
| Comparative | GI, | \textcircled{2} | He | 20 | 3 | weld |
| Ex. 5 | 0.7/1.6 | | | | | |
| Comparative | CR, | \textcircled{1} + \textcircled{2} | He/He | 20/20 | 3 | weld |
| Ex. 6 | 0.7/1.6 | | | | | |
| Inventive | CR, | \textcircled{1} + \textcircled{3} | He/He | 20/20 | 1 | base |
| Ex. 1 | 0.7/1.6 | | | | | material |
| Comparative | CR, | \textcircled{1} + \textcircled{3} | He/He | 10/10 | 2 | base |
| Ex. 7 | 0.7/1.6 | | | | | material |
| Inventive | CR, | \textcircled{1} + \textcircled{3} | He/He | 40/40 | 1 | base |
| Ex. 2 | 0.7/1.6 | | | | | material |
| Comparative | CR, | \textcircled{1} + \textcircled{3} | He/Ar | 20/20 | 2 | base |
| Ex. 8 | 0.7/1.6 | | | | | material |
| Comparative | CR, | \textcircled{1} + \textcircled{3} | He/N₂ | 20/20 | 3 | weld |
| Ex. 9 | 0.7/1.6 | | | | | |
| Inventive | CR, | \textcircled{2} + \textcircled{3} | He/He | 20/20 | 1 | base |
| Ex. 3 | 0.7/1.6 | | | | | material |
| Inventive | GI, | \textcircled{1} + \textcircled{3} | He/He | 20/20 | 1 | base |
| Ex. 4 | 0.7/1.6 | | | | | material |
| Inventive | GI, | \textcircled{2} + \textcircled{3} | He/He | 20/20 | 1 | base |
| Ex. 5 | 0.7/1.6 | | | | | material |
| Inventive | CR, | \textcircled{1} + | He/He/He | 20/20/20 | 1 | base |
| Ex. 6 | 0.7/1.6 | \textcircled{3} + \textcircled{4} | | | | material |
| Inventive | CR, | \textcircled{1} + | He/He/He | 20/20/20 | 1 | base |
| Ex. 7 | 0.7/1.6 | \textcircled{3} + \textcircled{5} | | | | material |
| Inventive | CR, | \textcircled{2} + | He/He/He | 20/20/20 | 1 | base |
| Ex. 8 | 0.7/1.6 | \textcircled{3} + \textcircled{4} | | | | material |
| Inventive | CR, | \textcircled{2} + | He/He/He | 20/20/20 | 1 | base |
| Ex. 9 | 0.7/1.6 | \textcircled{3} + \textcircled{5} | | | | material |

(In Table 2 above, \textcircled{4} and \textcircled{5} indicate a top shielding in the rear of the welding, and a bottom shielding in the rear of the welding in FIG. 3, respectively)

As can be seen from the results shown in Table 2, according to the Inventive Examples, the shielding gas was sprayed onto both a laser irradiation part and a rear side (lower welding portion) of the laser irradiation part during the laser welding, types and flow rates of the shielding gas satisfy the range of the present invention. Resultantly, all of the Inventive Examples ensure an excellent porosity occurrence grade (that is, porosity occurrence is suppressed), and fractures occur in the base material instead of the weld. From these results, it can be confirmed that the processability of the weld is improved.

In Comparative Examples 1 to 6, the shielding gas was not supplied to the rear side (lower welding portion) of the laser irradiation part. It can be confirmed that a large amount of porosities occurred in both the cold rolled steel sheet and the galvanized steel sheet, and the processability became poorer because the fracture occurred in the weld during processing. In comparison with the Inventive Examples, Comparative Example 7 was a case in which the flow rate of the shielding gas was slightly insufficient. The flow rate of the shielding gas did not fall within the range of the present invention, thus making it difficult to expect the effects of suppressing the occurrence of porosities which could be achieved in the present invention. In Comparative Examples 8 and 9, the shielding gas in the lower welding portion uses argon and nitrogen, and it can be confirmed that the porosity reducing effects are slightly inferior in this case as compared to the case of using helium gas.

FIGS. 4(a) and 4(b) are photographs obtained by radioanalysis of welds in the Comparative Example 1 and the Inventive Example 1. As illustrated in FIG. 4, it was observed that pores were formed at the weld in Comparative Example 1 but were not formed at the weld in Inventive Example 1.

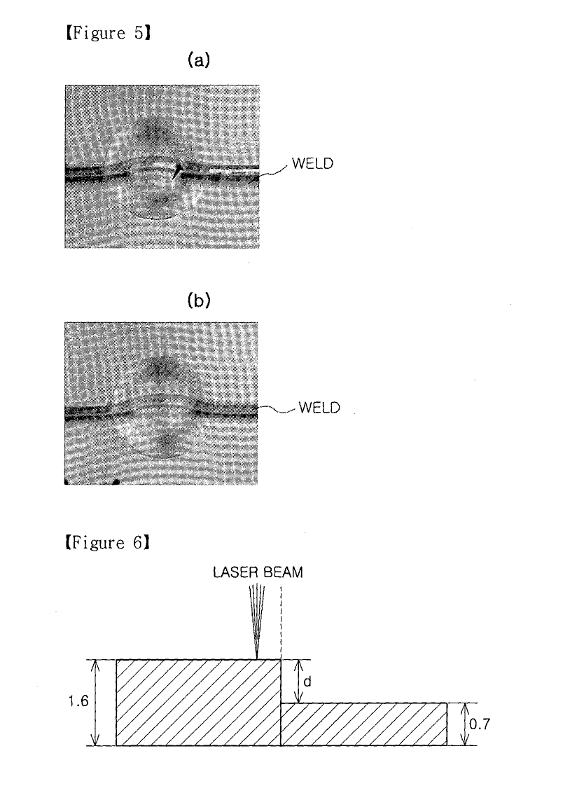

FIGS. 5(a) and 5(b) are photographs showing Erichsen test results of the welds in the Comparative Example 1 and the Inventive Example 1. As illustrated in FIG. 5, it was observed that pores were formed at the weld in the Comparative Example but were not formed in the weld in the Inventive Example.

### EXAMPLE 2

By using CR-A (thin plate) and CR-B (thick plate) of Table 1, welding defects and crack occurrence rates of welds were measured in the case in which welding was performed while changing a distance from an interface to the thick plate during laser irradiation and changing welding heat input under conditions of Table 3 below, and the results are shown in Table 3. The welding was performed by supplying helium gas to the laser irradiation part and the rear side thereof at the flow rate of 20 l/min, and the welding heat input was controlled by changing a laser output and a welding speed.

In Table 3, the welding defects were observed by focusing on shapes of beads, and an underfill was defined by setting a standard case in which a welded metal part sagged by 0.1 mm in comparison with a base material. Also, meltdown means a case in which the underfill phenomenon was dominant to cause molten metal to drop off and holes to be formed widely. A crack occurrence rate of the weld was evaluated using an Erichsen tester. That is, fractures of the weld were observed by pushing a ball up to a welding joint.

TABLE 3

| | | | | Crack |
|---|---|---|---|---|
| | Position of | welding heat | | occurence |
| | laser beam | input | Welding | rate |
| Classification | (mm) | (kW · min/m) | defect | (%) |
| Inventivce | 0 | 0.83 | None | 0 |
| Ex. 10 | | | | |
| Comparative | 0 | 2 | Underfill | 10 |
| Ex. 10 | | | | |
| Comparative | 0 | 3 | Underfill | 20 |
| Ex. 11 | | | | |
| Comparative | 0 | 4 | Meltdown | 40 |
| Ex. 12 | | | | |
| Comparative | 0 | 6 | Meltdown | 90 |
| Ex. 13 | | | | |
| Inventivce | 0.14 | 0.83 | None | 0 |
| Ex. 11 | | | | |
| Inventivce | 0.1 | 2 | None | 0 |
| Ex. 12 | | | | |
| Inventivce | 0.1 | 3 | None | 0 |
| Ex. 13 | | | | |
| Comparative | 0.1 | 4 | Meltdown | 10 |
| Ex. 14 | | | | |
| Comparative | 0.1 | 6 | Meltdown | 30 |
| Ex. 15 | | | | |
| Inventivce | 0.2 | 0.83 | None | 0 |
| Ex. 14 | | | | |
| Inventivce | 0.2 | 2 | None | 0 |
| Ex. 15 | | | | |
| Inventivce | 0.2 | 3 | None | 0 |
| Ex. 16 | | | | |
| Comparative | 0.2 | 4 | Underfill | 10 |
| Ex. 16 | | | | |
| Comparative | 0.2 | 6 | Meltdown | 20 |
| Ex. 17 | | | | |
| Inventivce | 0.25 | 0.83 | None | 0 |
| Ex. 17 | | | | |
| Inventivce | 0.25 | 2 | None | 0 |
| Ex. 18 | | | | |
| Inventivce | 0.25 | 3 | None | 0 |
| Ex. 19 | | | | |
| Comparative | 0.25 | 4 | Underfill | 10 |
| Ex. 18 | | | | |
| Comparative | 0.25 | 6 | Underfill | 10 |
| Ex. 19 | | | | |
| Comparative | 0.3 | 0.83 | Non-welding | 100 |
| Ex. 20 | | | | |
| Comparative | 0.3 | 2 | Non-welding | 100 |
| Ex. 21 | | | | |
| Comparative | 0.3 | 3 | Non-welding | 100 |
| Ex. 22 | | | | |
| Comparative | 0.3 | 4 | Non-welding | 100 |
| Ex. 23 | | | | |
| Comparative | 0.3 | 6 | Non-welding | 100 |
| Ex. 24 | | | | |

(The position of the laser beam is a distance from an interface between a thick plate and a thin plate up to the thick plate)

As illustrated in Table 3, it can be understood that as the irradiation position of the laser beam is increased, the range of the welding heat input, which does not cause welding defects and weld fracture to occur, is increased. That is, like Inventive Example 10, when the beam position is 0 mm, it exhibits good characteristics such that the welding heat input is 0.83 kW·min/m. However, in Inventive Examples 11 to 19 where the beam position was 0.1 to 0.25 mm, it can be understood that the welding heat input was extended to 0.83 to 5 kW·min/m. However, in Comparative Examples 20 to 24 where the beam position was 0.3 mm, the results of fractures of the weld were observed due to non-welding, regardless of the welding heat input.

Meanwhile, when the welding heat input was greater than 3 kW·min/m which was the range of the present invention, it can be observed that defects of the welds occur regardless of the beam position.

1. A laser welding method of performing welding by irradiating a portion to be welded with laser, the method comprising supplying a shielding gas to a laser irradiation part and a rear side of the laser irradiation part.

2. The laser welding method of claim 1, wherein the portion to be welded is a portion where steel materials with different thicknesses are butted and welded.

3. The laser welding method of claim 1, wherein the shielding gas to be supplied to the laser irradiation part is supplied in at least one direction of coaxial and lateral directions of a laser irradiation direction.

4. The laser welding method of claim 1, wherein the shielding gas is additionally supplied to the laser irradiation part or the rear side thereof after the laser welding.

5. The laser welding method of claim 1, wherein the shielding gas comprises any one of helium gas, argon gas, and a gas mixture thereof.

6. The laser welding method of claim 1, wherein the shielding gas is supplied at a flow rate of 15 to 40 l/min.

7. The laser welding method of claim 6, wherein the shielding gas is supplied at a flow rate of 15 to 20 l/min.

8. The laser welding method of claim 1, wherein a welding heat input of the laser is in a range of 0.83 to 3.0 kW·min/m.

9. The laser welding method of claim 2, wherein an irradiation position of the laser is 0.1 to 0.25 mm in distance from an interface between plates with different thicknesses to a thick plate.

10. A laser welded member comprising a weld which is welded by irradiating laser onto a portion to be welded, wherein 125 ppm or less by weight of nitrogen is contained in the weld.

11. The laser welded member of claim 10, wherein the weld is formed by irradiating a portion to be welded with laser by supplying a shielding gas to a laser irradiation part and rear side of the laser irradiation part.
